(19) United States
(12) Patent Application Publication
(10) Pub. No.: US 2014/0074280 A1
(43) Pub. Date: Mar. 13, 2014

(54) Horizontal Axis Drive Mechanism, Two-Axis Drive Mechanism, and Die Bonder

(71) Applicant: HITACHI HIGH-TECH INSTRUMENTS CO., LTD., Kumagaya-shi (JP)

(72) Inventors: Yoshihide ISHII, Kumagaya-shi (JP); Masayuki MOCHIZUKI, Kumagaya-shi (JP)

(73) Assignee: HITACHI HIGH-TECH INSTRUMENTS CO., LTD., Kumagaya-shi (JP)

(21) Appl. No.: 13/784,241

(22) Filed: Mar. 4, 2013

(30) Foreign Application Priority Data
Sep. 13, 2012 (JP) 2012-201729

(51) Int. Cl. G05B 19/18

(52) U.S. Cl. CPC G05B 19/18
USPC 700/186

(57) ABSTRACT

A horizontal axis drive mechanism includes a first linear motor including a first fixed section and a first movable section fixing a load section and moving the load section in the horizontal direction, a support body supporting the first fixed section, a first linear guide arranged between the support body and the first fixed section and moving the first fixed section, a rotation conversion type counter including a rotating body rotatably supported by the support body and a converting means converting movement of the first fixed section in the horizontal direction into rotation of the rotating body, and a control section controlling the position of the first movable section in the horizontal direction.

### BACKGROUND OF THE INVENTION

1. Field of the Invention

The present invention relates to a horizontal axis drive mechanism, a two-axis drive mechanism, the two-axis including the lifting axis, and a die bonder.

2. Description of the Related Art

One of semiconductor manufacturing devices is a die bonder boding a semiconductor chip (die) to a substrate such as a lead frame and the like. In the die bonder, the die is vacuum-sucked by a bonding head, lifted at a high speed, moved horizontally, is lowered, and is mounted on the substrate. One that lifts and lowers then is a lifting (Z) drive section.

Recently, the demand of improving the accuracy and increasing the speed of the die bonder is strong, and particularly, the demand of increasing the speed of the bonding head that is the heart of bonding is strong.

In general, when the speed of a device is increased, vibration caused by a high speed moving object increases, and it becomes hard to obtain the accuracy aimed by the device due to the vibration.

As a technology coping with the demand, there is one described in JP-A No. 2000-003920. JP-A No. 2000-003920 discloses a technology in which a linear motor is used as a drive section of a semiconductor manufacturing device such as a die bonder, permanent magnets and coil side are moved in directions opposite to each other, vibration is reduced, and the permanent magnets side is returned to the original position by a damper.

### SUMMARY OF THE INVENTION

As shown in FIG. 10, the linear motor is composed of a movable element (coil) and a stator, permanent magnets of the S pole and N pole are attached alternately in the proceeding direction of the motor onto the stator. The movable element is driven changing the phase according to the magnet on the stator. Control of the phase is executed by encoder count of a linear scale attached on a base.

However, because the stator that moves is utilized as a counter weight, a phase shift δ is generated between the phase of the movable element and the magnet on the stator due to change of the position relative to the linear scale, and the driving force F1 of the motor drops. FIG. 11 is a drawing showing an example of the relationship between the phase shift δ and the driving force F. The driving force F linearly drops relative to the phase shift δ. Although the condition changes according to various factors, in the example shown in FIG. 11, considering controllability of the motor, allowable drop of the driving force is 10-30% at the maximum, and the phase shift then, that is the movable limit distance of the counter section, is within several millimeters. As described below, in order to make the movable limit distance within several millimeters, the mass of the stator side as the counter weight becomes extremely large, and the device itself is also enlarged which is not practical. Further, as shown in JP-A No. 2000-003920, the phase shift cannot be made within several millimeters with a damper as done in the example described above. Furthermore, in JP-A No. 2000-003920, such recognition on the phase shift described above is not seen also.

In addition, JP-A No. 2000-003920 discloses a technology using the linear motor for a drive section in a flat plane, however a technology capable of increasing the speed and reducing the vibration in a two-axis drive mechanism using the linear motor also for the lifting axis is not disclosed. When only linear motor drive is employed, as shown in FIG. 9, both of the stator and the movable element of the Z-axis linear motor of the Z-axis drive become the load of a drive section in the horizontal direction, for example the Y-axis drive section in the Y-direction described below. When the torque of the Y-axis drive section is increased, power consumption and vibration increase, and when the weight of the stator and the movable element of the linear motor driven in the Z-axis is reduced, the torque in the Z-axis reduces and predetermined speed increase cannot be achieved.

Accordingly, the first object of the present invention is to provide a horizontal (Y) axis drive section of a linear motor light in weight, capable of reducing the vibration, and capable of increasing the speed.

Also, the second object of the present invention is to provide a two-axis drive mechanism including a lifting (Z) axis, capable of reducing the vibration in the horizontal axis and capable of increasing the speed in the lifting axis, and a die bonder using the two-axis drive mechanism.

In order to achieve the objects described above, the present invention has features described below at least.

The present invention is a horizontal axis drive mechanism including a first linear motor including a first fixed section and a first movable section fixing a load section and moving the load section in the horizontal direction, a support body supporting the first fixed section, a first linear guide arranged between the support body and the first fixed section and moving the first fixed section, a rotation conversion type counter including a rotating body rotatably supported by the support body and a converting means converting movement of the first fixed section in the horizontal direction into rotation of the rotating body, a linear sensor detecting the position of the first movable section in the horizontal direction relative to the support body, and a control section controlling the position of the first movable section in the horizontal direction based on output of the linear sensor.

Also, the present invention is a two-axis drive mechanism including the horizontal axis drive mechanism, a processing section, a second linear motor including a second movable section lifting and lowering the processing section along a second linear guide and a second fixed section fixed to the support body, a connecting section connecting the first movable section and the second movable section to each other via the first linear guide either directly or indirectly, a third linear guide moving the first movable section, the second movable section and the connecting section integrally in the vertical direction, and the load section integrated to the second movable section and loaded with a portion moving in the horizontal direction.

Further, the present invention is a die bonder including the two-axis drive mechanism in which a substrate is processed by the processing section.

According to the present invention, a Y (horizontal) axis drive section having horizontal (Y) axis driving section constitution of a linear motor light in weight, capable of reducing the vibration, and capable of increasing the speed can be provided.

Also, according to the present invention, a two-axis drive mechanism, the two-axis including a lifting (Z) axis, capable of reducing the vibration in the horizontal axis and capable of increasing the speed in the lifting axis and a die bonder using the same can be provided.

### BRIEF DESCRIPTION OF THE DRAWINGS

FIG. 1 is a schematic drawing of a die bonder that is an embodiment of the present invention as viewed from the top.

FIG. 2 is a cross-sectional view taken from line D-D shown in FIG. 1, and is a drawing explaining a constitution of the first example of a Y-axis drive mechanism, and the principle of the first example of a rotation conversion type counter applied to the Y-axis drive mechanism.

FIG. 3 is a drawing showing the second example of the Y-axis drive mechanism including the second example of the rotation conversion type counter.

FIG. 4 is a cross-sectional view taken from line A-A of the Z/Y-axis drive section in the position shown in FIG. 1 where the bonding head is present.

FIG. 5 is a drawing of the Z/Y-axis drive section shown in FIG. 4 as viewed along the arrow C.

FIG. 6 is a cross-sectional view taken from line E-E in FIG. 7 as viewed along the arrow F shown in FIG. 7.

FIG. 7 is a drawing showing the Y-axis drive mechanism as viewed along the arrow G in FIG. 6.

FIG. 8 is a drawing showing an example in which the fourth example of the rotation conversion type counter having a basic structure shown in FIG. 2 is applied to the second embodiment of the Z/Y-axis drive section.

FIG. 9 is a drawing showing a prior art of a two-axis drive mechanism of a linear motor having the Z-axis.

FIG. 10 is a drawing showing the problem of linear motor drive.

FIG. 11 is a drawing showing an example of the relationship between the phase shift δ and the driving force F.

FIG. 12 is a drawing showing each motion pattern of the bonding head and the like and the counter section mounted on the main drive section.

### DETAILED DESCRIPTION OF THE PREFERRED EMBODIMENTS

Below, embodiments of the present invention will be described based on the drawings.

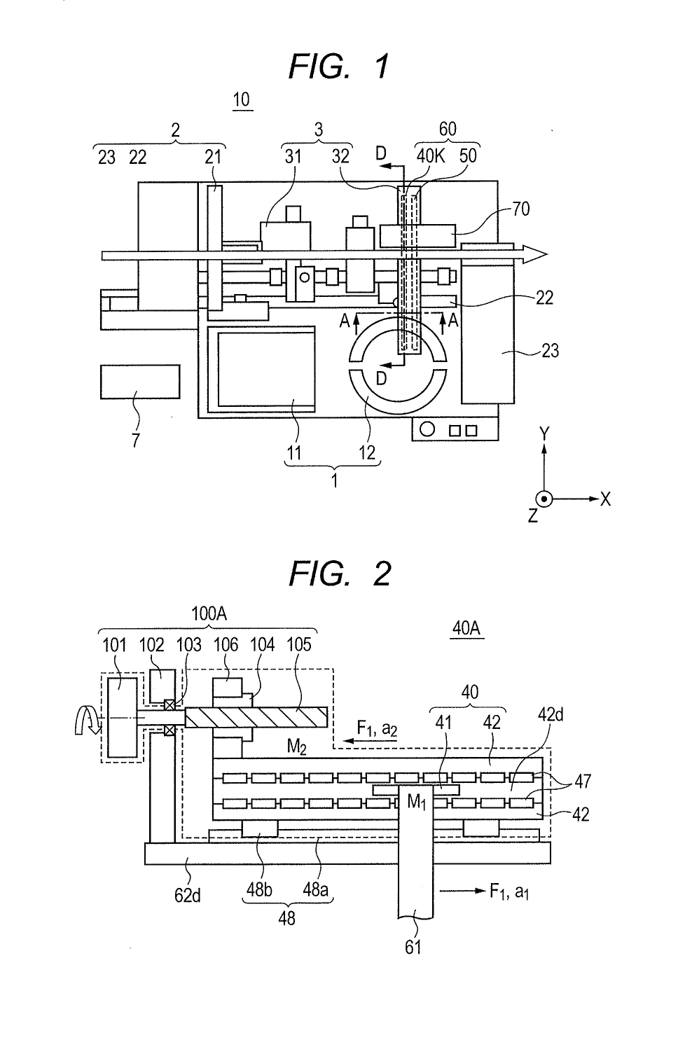

FIG. 1 is a schematic drawing of a die bonder 10 that is an embodiment of the present invention as viewed from the top. In broad classification, the die bonder includes a wafer supply section 1, a workpiece supply/convey section 2, a die bonding section 3, and a control section 7 monitoring the state of them and controlling them.

The wafer supply section 1 includes a wafer cassette lifter 11 and a pickup device 12. The wafer cassette lifter 11 includes a wafer cassette (not illustrated) filled with wafer rings, and supplies the wafer ring to the pickup device 12 one by one. The pickup device 12 moves the wafer ring so that a desired die can be picked up from the wafer ring.

The workpiece supply/convey section 2 includes a stack loader 21, a frame feeder 22 and an unloader 23, and conveys the workpiece (the substrate such as the lead frame and the like) in the direction of the arrow. The stack loader 21 supplies the workpiece to which the die is adhered to the frame feeder 22. The frame feeder 22 conveys the workpiece to the unloader 23 via processing positions of two locations on the frame feeder 22. The unloader 23 stores the workpiece having been conveyed.

The die bonding section 3 includes a preform section (die paste coating device) 31 and a bonding head section 32. The preform section 31 coats the workpiece, for example the lead frame, having been conveyed by the frame feeder 22 with the die adhesive agent by a needle. The bonding head section 32 picks up the die from the pickup device 12, rises, and moves the die to a bonding point on the frame feeder 22. Also, the bonding head section 32 lowers the die at the bonding point, and bonds the die onto the workpiece coated with the die adhesive agent.

The bonding head section 32 includes a Z/Y-axis drive section 60 lifting and lowering a bonding head 35 (refer to FIG. 2) in the Z (height) direction and moving the bonding head 35 in the Y direction, and an X drive section 70 moving the bonding head 35 in the X direction. The Z/Y-axis drive section 60 includes a Y-axis drive section 40 reciprocating the bonding head in the Y direction, that is between the pickup position inside the pickup device 12 and the bonding point, and a Z drive section 50 lifted or lowered so as to pick up the die from the wafer or to bond the die onto the substrate. The X drive section 70 moves the entire Z/Y-axis drive section 60 in the X direction that is the direction of conveying the workpiece. The X drive section 70 may be of a constitution of driving a ball screw by a servo motor, and may be of a constitution of driving the ball screw by a linear motor which will be described in the constitution of the Z/Y-axis drive section 60.

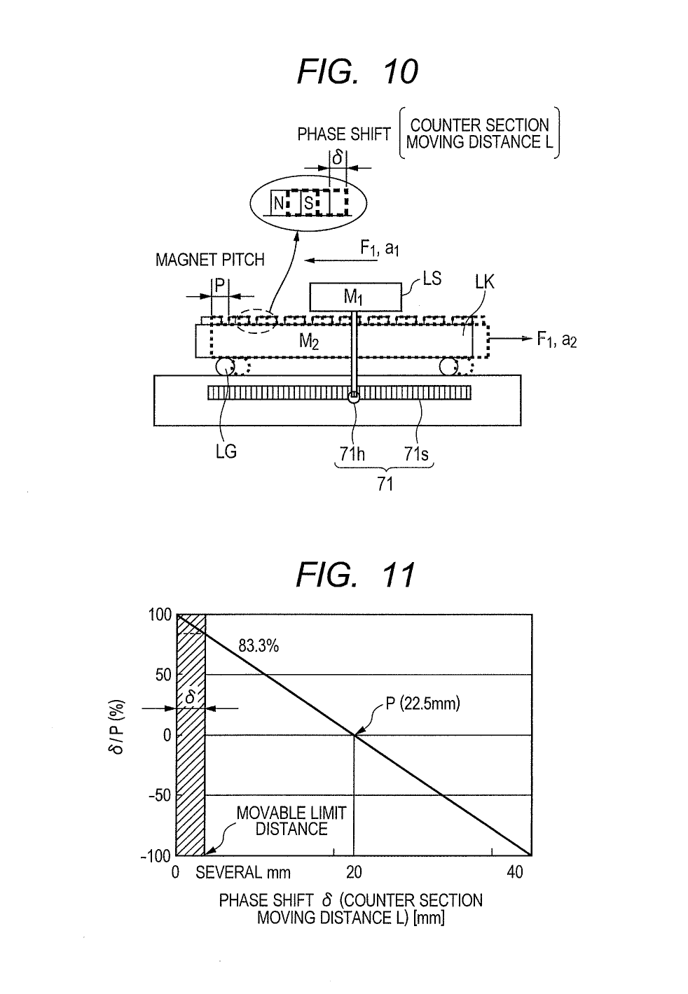

First, the problem occurring when the stator side is made a counter mechanism reducing the vibration and the phase shift as a linear motor shown in FIG. 10 will be described in detail. In FIG. 10, a linear motor stator LK fixed to a linear guide LG is utilized as the counter section. The operation principle is to reduce the vibration by making the counter section move in the opposite direction of the main drive section by a reactive force with the same magnitude of the drive force F1 of the main drive section (movable element), and absorbing the reactive action of the main drive section that becomes a cause of the vibration.

When respective contact surfaces are assumed to be sufficiently smooth in such counter mechanism, the relational expression between the motion of the main drive section (movable element) LS and the counter section is;

[Expression 1]

F₁=M₁×a₁=M2×a₂ (1)

wherein M₁: mass of the main drive section, a1: acceleration of the main drive section, a2: acceleration of the counter section, M2: mass of the counter section. In the counter mechanism, when the mass of the main drive section M1 and the acceleration of the main drive sectional are determined by the table specification, the acceleration of the counter section a2 can be controlled only by the mass of the counter section M2.

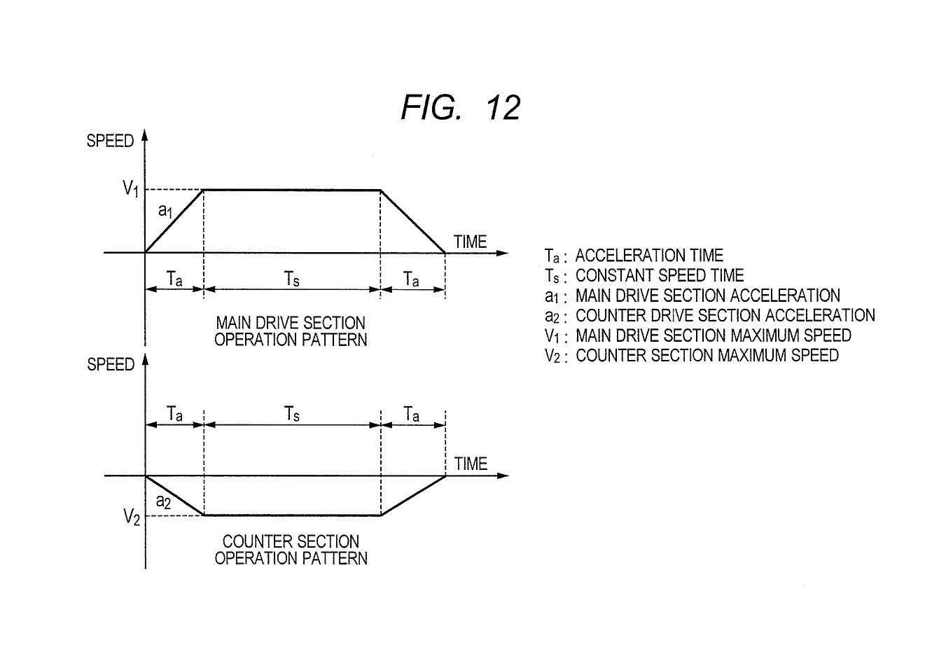

Next, with respect to the mass of the counter section M2 discussed in the problems to be solved, a case shown in FIG. 12 will be studied. The upper chart of FIG. 12 shows the motion pattern of the bonding head and the like mounted on the main drive section driven by the linear motor LM, and the lower chart of FIG. 12 shows the motion pattern of the counter section driven as the reactive action in order to reduce the vibration as a counter weight.

In this operation pattern, when the movable limit distance of the counter section is made Lm, the relationship of the movable limit distance of the counter section and the mass of the counter section M2 is as per the following expression from the relational expression (1).

[Expression 2]

M₂=M₁×a₁ (2)

When various values of the device with a conventional are substituted for the expression (2), in order to make Lm=several millimeters or less, the mass of the counter section M2 becomes 250-500 kg. Therefore, the mass of the counter section M2 is large, and it is impossible to mount the counter section on an actual machine.

In order to solve the problem, in the invention of the present application, as shown in the expression (3), energy of the linear motion of the reactive force F1 of the main drive section that becomes a cause of the vibration is converted into other kinetic energy, and the mass of the counter section M2 is reduced.

[Expression 3]

{reactive motion energy of main drive section}={kinetic energy of counter section}+{other kinetic energy} (3)

As the other kinetic energy, rotational motion energy, elastic energy of a spring and the like, thermal energy of a damper and the like, and etc. can be cited, however, in the invention of the present application, rotational motion energy is used which can achieve the movable limit distance of the counter section set in units of millimeters.

FIG. 2 is a cross-sectional view taken from line D-D shown in FIG. 1, and is a drawing explaining a constitution of the first example 40KA of a Y-axis drive mechanism 40K, and the principle of the first example 100A of a rotation energy conversion type counter (hereinafter simply referred to as a rotation conversion type counter) 100 applied to the Y-axis drive mechanism.

The Y-axis drive mechanism 40KA includes the Y-axis drive section 40 moving the processing section such as the bonding head 35 and the like that become the load section in the Y direction, and the rotation conversion type counter 100.

The Y-axis drive section 40 includes a Y-axis fixed section 42 of a squared C shape (refer to FIG. 4) including a fixed magnet section 47, and a Y-axis fixed section linear guide 48 arranged between the Y-axis fixed section and a Y-axis drive section support body 62d and allowing the Y-axis fixed section 42 to move in the Y direction. The fixed magnet section 47 includes upper and lower fixed magnet sections 47u, 47d in which a number of permanent magnets of the N pole and S pole are arrayed alternately in the Y direction. The linear guide 48 includes a linear rail 48a arranged in the Y-axis drive section support body 62d, and plural linear sliders 48b fixed to the Y-axis fixed section 42 and moving on the linear rail 48a.

Also, the Y-axis drive section 40 includes a Y-axis movable section 41 including at least one set of the N-pole and S-pole in the arraying direction and including a movable element inserted to a recess 42d of a squared C shape and moving inside the recess. A connection section 61 is connected to the Y-axis movable section 41 as the load section, and the connection section is tied to the processing section.

On the other hand, the rotation conversion type counter 100A is arranged at one end of the Y-axis drive section support body 62d. The rotation conversion type counter 100A includes a converting means converting the moment of inertia producing the moment of inertia described below and movement of the Y-axis drive section support body 62d in the horizontal direction into rotation of the rotating body. The converting means includes a ball screw 105 with one end side thereof being fitted in a nut 104, and with the other end side thereof being provided with a rotating body 101 fixed so that the rotation center of the ball screw agrees to the rotation center of the rotating body. The ball screw 105 is rotatably supported by a bearing 103 arranged in a flat section 105a on the other end side where the screw thread is not cut and a nut 104 fixed to a nut support section 106. The bearing 103 is arranged in a penetration section of the flat section 105a of a rotating body support body 102 fixed to the drive section support body 62d. The nut support section 106 is fixed to the Y-axis fixed section 42.

With such constitution, when the Y-axis movable section 41 constituting the main drive section moves to the direction of the arrow with the acceleration a1, the reactive force F1 is generated in the opposite direction in the Y-axis fixed section 42 constituting the counter section. By this reactive force F1, the Y-axis fixed section 42 is moved to the opposite direction, and the rotating body 101 is rotated via the ball screw 105. Also, the ball screw 105 may transmit rotation to the rotating body 101 via gears, pulleys and the like instead of directly contacting the rotating body.

In the direct motion type in which only the Y-axis fixed section 42 (counter section) reduced the vibration, the reactive force F1 received by the counter section was received only by the mass M2 of the Y-axis fixed section 42 (counter section), however, in the rotation conversion type, the reactive force F1 is received by the mass M2 of the counter section and the moment of inertia I of the rotating body, and the mass of the counter section can be reduced.

In this mechanism, the relationship between the main drive section and the counter section can be expressed by the expression below.

[Expression 4]

F₁=M₁×a₁=(M₂+I)×a₂ (4)

Here, I is the moment of inertia of the rotating body taking the ball screw into consideration. The mass M1 of the main drive section in FIG. 2 is the total of the mass of the Y-axis movable section 41, a support body 62, and the portion moving integrally with the support body 62. On the other hand, the mass of the counter section is the total mass of the counter section shown by the broken line such as the rotating body 101, the ball screw 105, the nut 104, the linear slider 48b and the like moving integrally with the Y-axis fixed section 42.

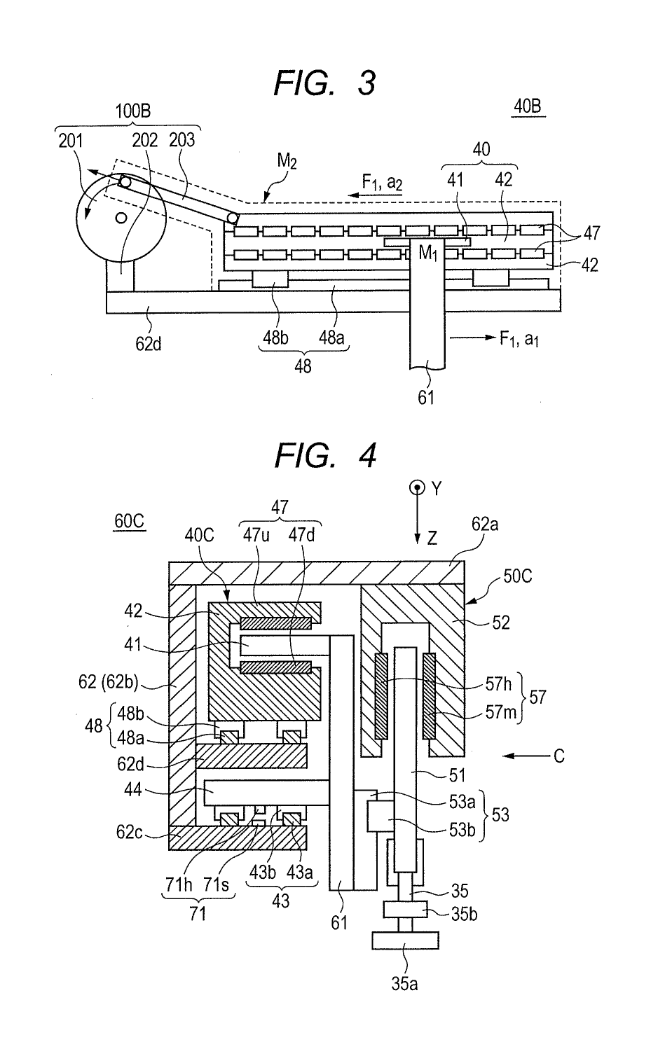

FIG. 3 is a drawing showing a second example 40KB of the Y-axis drive mechanism 40K including a second example 100B of the rotation conversion type counter 100.

The point of the example 2 of the Y-axis drive mechanism 40K different from the example 1 is the rotation conversion type counter, and the Y-axis drive section is same with that of the example 1. The rotation conversion type counter 100B uses a link 203 instead of the ball screw 105 as a converting means, and converts the linear motion of the Y-axis fixed section 42 into the rotational motion of a rotating body 201. The rotating body 201 is rotatably supported by a rotating body support body 202 fixed to the drive section support body 62d so as to be parallel to the paper surface and rotatably supporting the rotating body 201.

Even in the example 2 of the rotation conversion type counter, the effect same to that of the example 1 can be exerted.

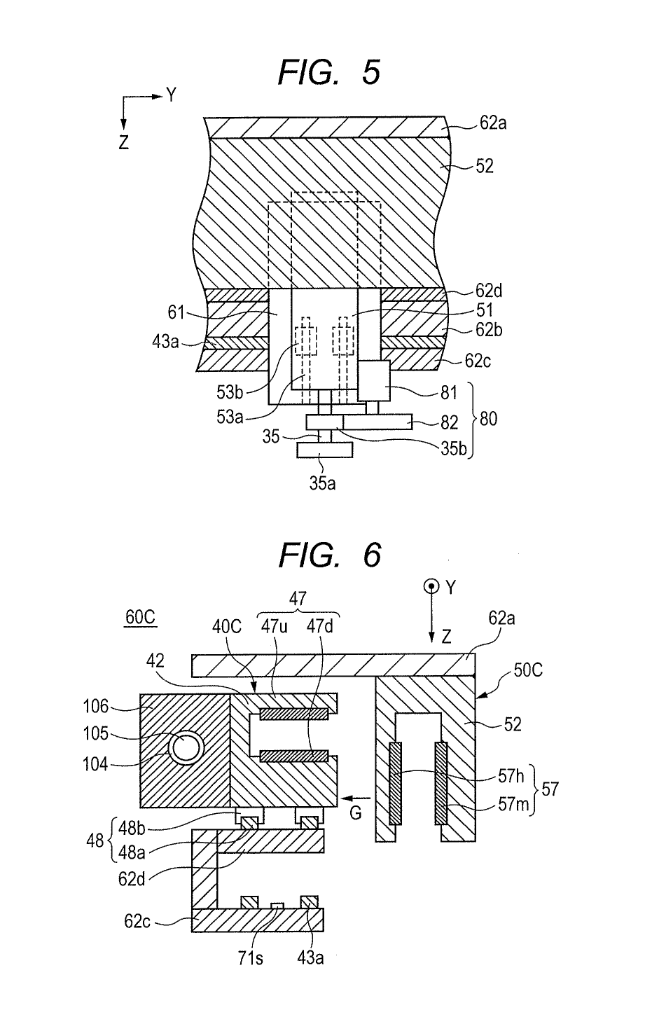

Next, a first embodiment 60C of the Z/Y-axis drive section 60 shown in FIG. 1 will be described using the drawing. First, the constitution and motion of the Z/Y-axis drive section 60C will be described using FIG. 4 and FIG. 5. FIG. 4 is a cross-sectional view taken from line A-A of the Z/Y-axis drive section 60C at a position shown in FIG. 1 where the bonding head 35 is present. FIG. 5 is a drawing of the Z/Y-axis drive section 60C shown in FIG. 4 as viewed along the arrow C.

The Z/Y-axis drive section 60C that is the first embodiment includes a Y-axis drive section 40C, a Z drive section 50C, the connecting section 61 connecting the Y-axis movable section 41 of the Y-axis drive section 40C and a Z-axis movable section 51 of the Z drive section 50 to each other, and the support body 62 of lateral L-shape supporting all of them. The Z drive section 50C includes the bonding head 35 that is the processing section, and a rotation drive section 80 rotating the bonding head 35 around the Z-axis. Also, for the purpose of easy understanding of the description below, in FIG. 4 and FIG. 5, the Y-axis movable section 41, the Z-axis movable section 51, and the portion moving integrally with the connecting section 61 are shown white, and the other portions fixed to the support body 62 are shown by diagonal lines. Further, the support body 62 includes an upper support body 62a, a side support body 62b, a lower support body 62c and the Y-axis drive section support body 62d.

The Y-axis drive section 40C has the structure same to that of the Y-axis drive section 40 shown in FIG. 2. That is, the Y-axis drive section 40C includes the Y-axis fixed section 42 of a squared C shape including the upper and lower fixed magnet sections 47 (47u, 47d) in which a number of permanent magnets of the N pole and S pole are arrayed, and the Y-axis fixed section linear guide 48 allowing the Y-axis fixed section 42 to move in the Y direction. The Y-axis fixed section linear guide 48 is arranged between the Y-axis fixed section and the Y-axis drive section support body 62d.

Also, the Y-axis drive section 40C includes the Y-axis movable section 41 including at least one set of electro-magnets of the N-pole and S-pole in the arraying direction, inserted to a recess of a squared C shape and moving inside the recess, and a linear sensor 71 detecting the position in the Y direction of the Y-axis movable section 41. The linear sensor 71 detects the position in the Y direction of the bonding head 35 described below moving along with the Y-axis movable section 41, and detects the position of the Y-axis movable section 41. The Y-axis drive section 40C can stably move the Y-axis movable section 41 in the Y direction by a Y-axis guide section 44 fixed to the connecting section 61 supporting the Y-axis movable section 41 and including a Y-axis linear guide 43 arranged between the connecting section and the lower support body 62c.

The Y-axis fixed section 42 is arranged over the substantially entire area of the Y-axis drive section 40 shown by a broken line of FIG. 1 so that the Y-axis movable section 41 can move over a predetermined range. Also, the Y-axis fixed section linear guide 48 and the Y-axis linear guide 43 respectively include two linear rails 48a, 43a extending in the Y direction and linear sliders 48b, 43b moving on the linear rails. As shown in FIG. 4, the linear sensor 71 includes a scale 71s arranged over the substantially entire area of the Y-axis drive section 40, and an optical detecting section 71h fixed to the Y-axis guide section 44 and moving in the Y direction. Movement to a target position in the Y direction can be controlled by position control, speed control or the like based on output of the linear sensor 71. This control is executed by the control section 7 in the present embodiment.

In the present embodiment, the Y-axis fixed section linear guide 48 was arranged separately from the Y-axis linear guide 43. However, the Y-axis linear guide 43 may be used as the Y-axis fixed section linear guide 48 by arranging respective linear sliders 48b, 43b so as not to interfere with each other.

The Z drive section 50C includes a Z-axis fixed section 52 of an inverted U-shape, the Z-axis movable section 51 inserted to the recess of the inverted U-shape and moving inside the recess, and a Z-axis linear guide 53 guiding lifting and lowering of the Z-axis movable section 51. Similarly to the Y-axis drive section 40C, the Z-axis fixed section 52 includes right and left fixed magnet sections 57 (57h, 57m) in which a number of electro-magnets of the N pole and S pole are alternately arranged in the Z direction. The Z-axis movable section 51 includes at least one set of electro-magnets of the N pole and S pole in the upper part in the arraying direction of the Z-axis fixed section 52, is inserted to the recess of the inverted U-shape, and moves inside the recess. The Z-axis linear guide 53 is arranged between the Z-axis movable section 51 and the connecting section 61, and includes two linear rails 53a fixed to the connecting section 61 and extending in the Z direction, and a linear slider 53b fixed to the Z-axis movable section 51 and moving on the linear rails.

The Z-axis movable section 51 is tied with the Y-axis movable section 41 via the connecting section 61, and when the Y-axis movable section 41 moves in the Y direction, the Z-axis movable section 51 jointly moves in the Y direction. Also, at a predetermined position of the movement destination, the Z-axis movable section 51 (the bonding head 35) is lifted and lowered.

The bonding head 35 is arranged at the distal end of the Z-axis movable section 51 so as to be rotatable by a rotation drive section 80 via a gear 35b, and includes a collet 35a for sucking the die at own distal end. Also, the rotation drive section 80 controls the rotation attitude of the bonding head 35 by a motor 81 fixed to the Z-axis movable section 51 via gears 82, 35b.

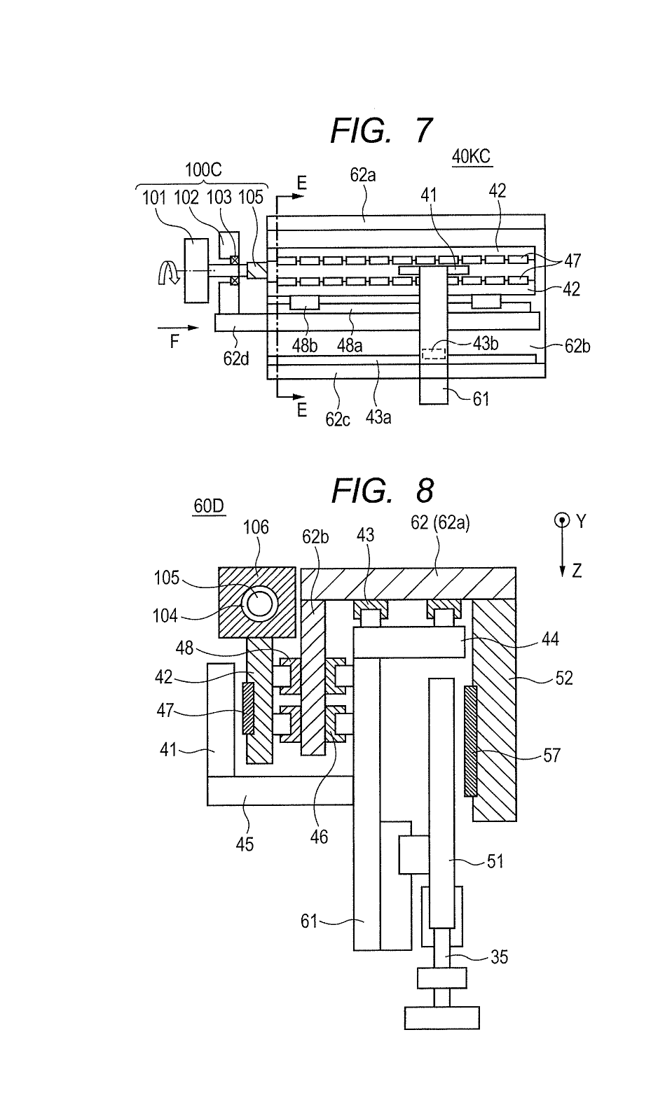

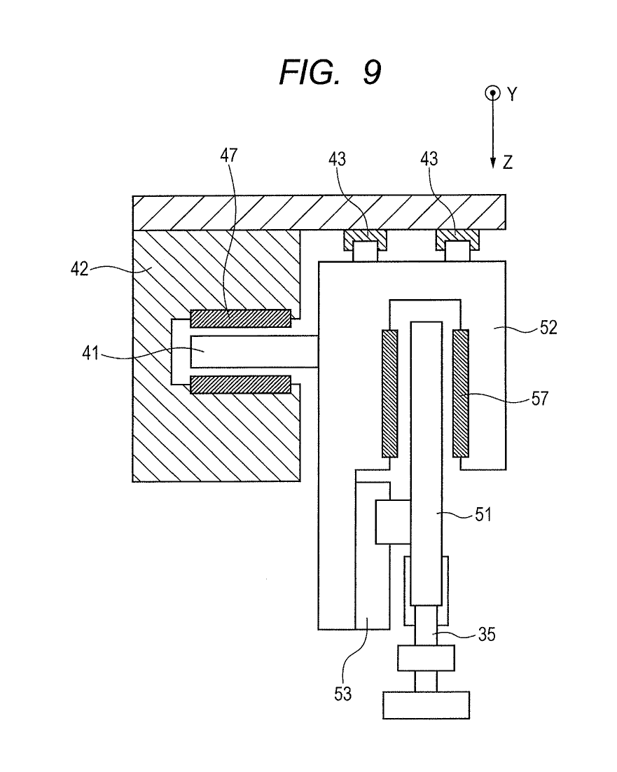

Next, a third example 100C of the rotation conversion type counter 100 in the Y-axis drive section 60C will be described using FIG. 6 and FIG. 7. FIG. 6 is a cross-sectional view taken from line E-E in FIG. 7 as viewed along the arrow F shown in FIG. 7. FIG. 7 is a drawing showing a Y-axis drive mechanism 40KC as viewed along the arrow G in FIG. 6. Because the Y-axis drive section 40C is same to that of FIG. 4 and FIG. 5, description thereon will be omitted.

The rotation conversion type counter 100C is basically same to that of FIG. 2. The different point is that the nut support section 106 of the rotation conversion type counter 100C is fixed to the Y-axis fixed section 42 on the opposite side of the Z-axis drive section 50C with respect to the Y-axis drive section 40C. Accordingly, as shown in FIG. 7, the nut 104, the thread side distal end of the ball screw 105 and the nut support section 106 shown in FIG. 6 are hidden by the Y-axis fixed section 42 and are not shown.

It is a matter of course that the rotation conversion type counter 100C may be arranged on the upper side of the Y-axis fixed section 42 as shown in FIG. 2. Also, as done in the rotation conversion type counter 100B shown in FIG. 3, it is also possible that the side part of the Y-axis fixed section 42 and the counter rotating body support body 102 are arranged so as to be apart from each other, and that the rotation conversion type counter 100A or 100C of FIG. 2 or FIG. 7 is lowered and is arranged between the side part on the extension of the Y-axis fixed section 42.

In the first embodiment 60C of the Z/Y-axis drive section 60, the mass M1 of the main drive section is the total mass of the portion shown in white in FIG. 4 moving integrally with the Y-axis movable section 41. On the other hand, the mass of the counter section M2 is the total mass of the Y-axis fixed section 42 as well as the rotating body 101, the ball screw 105, the nut 104, the linear slider 48b and the like moving integrally with the Y-axis fixed section 42 as described in FIG. 2.

According to the Z/Y-axis drive section 60 described above, by arranging the rotation conversion type counter, the phase shift can be made within the moving range of the counter section, the driving force of the linear motor can be secured, the mass of the counter section can be reduced, and movement at a high speed in the Y direction becomes possible.

FIG. 8 shows an example in which a fourth example 100D of the rotation conversion type counter having a basic structure shown in FIG. 2 is applied to a Z/Y-axis drive section 60D that is the second embodiment of the Z/Y-axis drive section 60. Also, FIG. 8 is a drawing corresponding to FIG. 6 of the Z/Y-axis drive section 60C that is the first embodiment. In FIG. 8, those having the constitution or function basically same to those of the Z/Y-axis drive section 60C and the rotation conversion type counter 100A are marked with a reference sign same to that in FIG. 4.

First, the Z/Y-axis drive section 60D will be described, and the rotation conversion type counter 100D will be described thereafter.

The points of the Z/Y-axis drive section 60D different from the Z/Y-axis drive section 60C that is the first embodiment will be described. The first point is that the Y-axis fixed section 42 is made of an I-shape long in the Z direction, and the Y-axis movable section 41 is arranged so as to be parallel to the Y-axis fixed section 42. The second point is that the fixed magnet section of the Y-axis is made 47 that is present on one side only. The third point is that a Y-axis movable section fixing section 45 is provided in a gap against the connecting section 61 to fix the Y-axis movable section 41. The fourth point is that the side support body 62d is shortened, and the Y-axis fixed section linear guide 48 allowing the Y-axis fixed section 42 to move is arranged on one side thereof.

The fifth point is that the Y-axis guide section 44 supporting the Y-axis liner guide 43 that allows movement in the Y direction of the Y-axis movable section 41 is relocated from the lower support body 62c to the upper support body 62a. The sixth point is that the Z-axis fixed section 52 is made of an I-shape instead of a U-shape, and the fixed magnet sections 57h, 57m are changed to the fixed magnet section 57 of one side only. The seventh point is that a linear guide 46 is arranged between the side support body 62b and the connecting section 61 in order to prevent swinging to the right and left of the movable integrated section in moving in the Y direction.

Also, the linear guide 46 stabilizing such movement may be arranged between the Y-axis fixed section 42 or the Z-axis fixed section 52 and the connecting section 61 in the first embodiment. Further, the second embodiment is different from the first embodiment in various points, however it is not necessary to differentiate all, although there are also different points interlockingly.

Other points are same to the Z/Y-axis drive section 60C that is the first embodiment.

On the other hand, the point of the rotation conversion type counter 100D different from the rotation conversion type counter 100A is that the rotation conversion type counter 100D is arranged on the Y-axis fixed section 42 of an I-shape. More specifically, the nut support section 106 shown in FIG. 2 is fixed to the upper part of the Y-axis fixed section 42 of an I-shape, and the rotating body support body 102 is fixed to the upper support body 62a or the side support body 62b. Other basic points are same to the rotation conversion type counter 100A.

In the second embodiment 60D of the Z/Y-axis drive section 60, the mass M1 of the main drive section is the total mass of the portion shown in white in FIG. 8 moving integrally with the Y-axis movable section 41 similarly to the Z/Y-axis drive section 60C although the structure is different. On the other hand, the mass M2 of the counter section is the total mass of the Y-axis fixed section 42 as well as the rotating body 101, the ball screw 105, the nut 104, the linear slider 48b and the like moving integrally with the Y-axis fixed section 42 as described in FIG. 2.

According to the Z/Y-axis drive section 60D described above, by arranging the rotation conversion type counter, the phase shift can be made within the moving range of the counter section, the drive force of the linear motor can be secured, the mass of the counter section can be reduced, and movement in the Y direction at a high speed becomes possible.

In the embodiment 60D of the Z/Y-axis drive section 60 described above, an example of the type of FIG. 2 was used as the rotation conversion type counter, however an example of the type shown in FIG. 3 can also be applied in a similar manner. It is a matter of course that various methods for rotating the rotating body by moving the Y-axis drive section can be considered, and these methods can be applied to embodiments of the Z/Y-axis drive section 60.

According to the examples of the rotation conversion type counter described above, a Y (horizontal)-axis drive section having Y (horizontal)-axis drive section constitution of a linear motor light in weight, capable of reducing the vibration and capable of increasing the speed can be provided.

According to the examples of the rotation conversion type counter or the embodiments of the Z/Y-axis drive section described above, the speed in the lifting axis can be increased, the vibration in the Y (horizontal) axis can be reduced, and a two-axis drive mechanism, the two-axis including the Z (lifting) axis, and a die bonder including it can be provided.

Although the examples or the embodiments in relation with the present invention were described above, a variety of alternatives, modifications, or alterations are possible for a person with an ordinary skill in the art based on the above description, and the present invention is to include the variety of alternatives, modifications, or alterations within a scope not departing from the object thereof.

What is claimed is:

1. A horizontal axis drive mechanism comprising:
a first linear motor including a first fixed section and a first movable section fixing a load section and moving the load section in the horizontal direction;
a support body supporting the first fixed section;
a first linear guide arranged between the support body and the first fixed section and moving the first fixed section;
a rotation conversion type counter including a rotating body rotatably supported by the support body and a converting means converting movement of the first fixed section in the horizontal direction into rotation of the rotating body;
a linear sensor detecting the position of the first movable section in the horizontal direction relative to the support body; and
a control section controlling the position of the first movable section in the horizontal direction based on output of the linear sensor.

2. The horizontal axis drive mechanism according to claim 1, wherein the converting means includes a nut fixed to the first fixed section and a ball screw fitted in the nut being connected to the rotating body with an end thereof.

3. The horizontal axis drive mechanism according to claim 2, wherein the connection is fixed connection to the center of rotation of the rotating body.

4. The horizontal axis drive mechanism according to claim 1, wherein the converting means includes a link with one end thereof being rotatably connected to the first fixed section and with the other end thereof being rotatably connected to the peripheral part of the rotating body.

5. The horizontal axis drive mechanism according to claim 1, wherein the rotation conversion type counter is arranged at an end of the support body.

6. A two-axis drive mechanism comprising:
the horizontal axis drive mechanism according to claim 1;
a processing section;
a second linear motor including a second movable section lifting the processing section along a second linear guide and a second fixed section fixed to the support body;
a connecting section connecting the first movable section and the second movable section to each other via the first linear guide either directly or indirectly;
a third linear guide moving the first movable section, the second movable section and the connecting section integrally in the vertical direction; and
the load section integrated to the second movable section and loaded with a portion moving in the horizontal direction.

7. The two-axis drive mechanism according to claim 6, wherein the second movable section is arranged orthogonal to the first movable section, and the first linear guide and the second linear guide are arranged so as to be parallel to each other.

8. The two-axis drive mechanism according to claim 6, wherein the second movable section is arranged so as to be parallel to the first movable section, and the second fixed section is also arranged so as to be parallel to the first fixed section.

9. A die bonder comprising the two-axis drive mechanism according to claim 6, wherein a substrate is processed by the processing section.

10. The die bonder according to claim 9, wherein the processing section is either a bonding head that picks up a die from a wafer and bonds the die to the substrate, or a needle coating a die adhesive agent on the substrate.
